(19) United States
(12) Patent Application Publication
(10) Pub. No.: US 2025/0187824 A1
(43) Pub. Date: Jun. 12, 2025

(54) METHOD FOR SAFE ACCESS TO A HAZARD AREA IN A RACKING SYSTEM, CONTROL UNIT, COMPUTER PROGRAM PRODUCT, AND SECURING DEVICE

(71) Applicant: Gebhardt Foerdertechnik GmbH, Sinsheim (DE)

(72) Inventors: Marco Gebhardt, Sinsheim (DE); Michael Auer, Bad Rappenau (DE); Jürgen Nosch, Feldkirch (AT)

(21) Appl. No.: 18/970,429

(22) Filed: Dec. 5, 2024

(51) Int. Cl. B65G 1/04

(52) U.S. Cl. CPC B65G 1/0421; B65G 2207/40

(57) ABSTRACT

A method for safe access to a hazard area in a racking system using simple means is provided, wherein the racking system has a rack storage unit with a storage rack and a rack operating device for operating the storage rack. The storage rack has one or more compartments for stored goods in one rack level or in several rack levels arranged one above the other. The rack operating device has a lifting unit that is movable in a vertical direction. The method comprises 1) requesting access to the hazard area, 2) interrupting any operation of the storage rack by the rack operating device, and 3) granting access to the hazard area. After requesting access to the hazard area, the lifting unit is moved in a vertical direction to a lowest height and/or to a preferred height and secured at the preferred height in the vertical direction.

### BACKGROUND

### Technical Field

The disclosure relates to a method for safe access to a hazard area in a racking system, in particular to a rack operating device in a racking system designed as a storage and retrieval system.

The present disclosure further relates to a control unit and to a computer program product for carrying out the method. The present disclosure further relates to a securing device for safe access to a hazard area in a racking system.

### Description of the Related Art

Methods for safe access to a hazard area in a racking system, in particular to a rack operating device in a racking system of the type in question designed as a storage and retrieval system, have been known in practice for years. The racking systems usually have a rack storage unit with at least one storage rack and at least one rack operating device for operating the storage rack. The at least one storage rack can have one or more compartments for stored goods in one rack level or in several rack levels arranged one above the other. The at least one rack operating device has a lifting unit arranged to be movable in the vertical direction. The rack operating device can thus transport stored goods in a vertical direction using the lifting unit and can place them into or remove them from racking systems. A lifting unit can have a lifting basket with guide elements for vertical movement. The guide elements can define the degree of freedom of the lifting unit in the vertical direction and can be designed as rollers, for example. According to another embodiment, the guide elements can be designed as linear rails. The lifting basket can have aluminum profiles for cost-effective production and weight reduction. Alternatively or additionally, the lifting basket could be designed so as to include thin sheets, preferably metal sheets, or composite materials. The lifting unit can further carry at least one load-handling device which can be moved horizontally in the lifting unit. Specifically, the load-handling device can be movable in the lifting basket. The load-handling device can be designed as a module including extension drive and guide rails. All types of pallets, containers, trays, and boxes can be used as load carriers for the stored or conveyed goods. This also includes all load carriers that are used, for example, in supermarkets—for example, a package with six bottles of barbecue sauce that has only a cardboard “tray” on the bottom and is film-wrapped/shrink-wrapped. Envelopes and/or polybags—for example, containing textile goods—can also be considered stored goods. Often, there are rack aisles between two storage racks, which can be part of the hazard area.

In order to be able to carry out troubleshooting/maintenance/repair work, etc., it is necessary from time to time to make the hazard area(s) accessible in a safe way for operating personnel who are to carry out the aforementioned work on parts of the racking system. Known methods for safe access to a hazard area in a racking system, in particular to a rack operating device in a racking system designed as a storage and retrieval system, comprise the following method steps:
1) requesting access to the hazard area by the operating personnel,
2) interrupting any operation of the storage rack by at least one of the rack operating devices, and
3) granting access to the hazard area for the operating personnel.

In the case of known racking systems and rack operating devices, safe access to the hazard areas for the operating personnel is problematic in case of fault. One reason for this is that known racking systems have masts in front of the storage racks. The masts extend in the vertical direction. The lifting units can be moved vertically on the masts so that the rack operating devices can serve the storage racks of the racking system. In known racking systems and rack operating devices, these masts can partially block the operating personnel's access to the lifting unit.

Also, standing in the areas below the lifting units of the rack operating devices is dangerous for the operating personnel, because the lifting units move in a highly automated manner. These hazard areas are still located below stored goods and therefore below suspended loads. Also, the lifting units can be moved vertically to a height at which collisions with the operating personnel and thus injuries are possible.

Rack operating devices can have a drive device to move the lifting unit via at least one support means extending in the vertical y-direction, preferably in the vertical upward and/or downward direction. The suspension means can be designed, for example, as a belt or as a rope. In known methods for safe access to a hazard area in a racking system, the operating personnel, for example, temporarily disconnect one or more drive devices for moving the respective lifting units in the vertical y-direction from the power supply or bring the lifting units into a safe control state. However, the means by which the lifting units are held can be manipulated. For example, a brake can be released, causing the lifting unit to fall and hit operating personnel standing underneath. The power supply may be interrupted or the area secured, for example, after the operating personnel have requested access to the hazard area, but before the operating personnel are granted access to the hazard area. Moreover, the operating personnel can manually secure one or more of the lifting units immediately after having been granted access to the hazard area in accordance with step 3) before starting any troubleshooting/maintenance/repair work, etc. In order to avoid accidents at work, the safety requirements regarding procedures for safe access to hazard areas in racking systems are overall rather strict. In case of a malfunction/defect—for example, if a brake does not engage properly and/or slips or if a suspension means fails—the operating personnel may be injured. There is therefore a need for additional, even redundant, safety devices.

### BRIEF SUMMARY AND GENERAL DESCRIPTION

The present disclosure provides a method for safe access to a hazard area in a racking system of the type mentioned at the outset such that safe access to the parts of the racking system, in particular to a rack operating device in a racking system designed as a storage and retrieval system, is ensured by simple means. Furthermore, a corresponding control unit and a computer program product for carrying out the method and a securing device for automatically securing a lifting unit for safe access to the hazard area in the racking system, in particular to the rack operating device in the racking system designed as a storage and retrieval system, are to be provided.

According to various embodiments, the method is characterized in that, after requesting access to the hazard area according to step 1), at least one of the lifting units is moved in the vertical direction to a lowest height and/or is moved to a preferred height and secured at the preferred height in the vertical direction.

The lowest position can be the lowest position in the vertical y-direction that the lifting unit of the rack operating device can reach due to its design—in other words, the lower approach dimension or the lowest technically reasonable position. What is decisive is that the lifting unit is located close to the ground in the lowest position and can no longer fall down. A disadvantage of a rather large lower approach dimension is that the storage capacity decreases because there is overall less space available for rack levels—for example, in the warehouse building. Also, the risk of operating personnel standing completely or partially underneath the lifting unit increases.

Particular advantages arise if, after requesting access to the hazard area in accordance with step 1), at least one of the lifting units is moved in the vertical direction to a lowest height. As a result, it is no longer mandatory to manually secure the lifting unit, at least in the vertical direction, because the risk of operating personnel being underneath an unsecured lifting unit is eliminated. A-possibly further-falling down of the lifting unit is ruled out.

The drive device can, for example, be arranged centrally below the lifting unit. In this case, the space required for the drive or a motor of the drive device in the z-direction—i.e., in the horizontal direction into the storage rack or out of the storage rack and into the rack aisle—is minimized. The drive is relatively easily accessible for operating personnel carrying out troubleshooting/maintenance/repair work, etc. For safety reasons, it is possible to unplug one shaft of the motor from an adjacent rack operating device and to thus disconnect it from the power supply. Moreover, safety can be increased by having two suspension means-one to the left and one to the right of the drive. However, this variant results in a relatively large lower approach dimension. Since the drive device takes up the space at the foot of the mast, the lifting unit cannot be lowered all the way to the ground.

As a variant, the drive device can be outside the storage rack in the z-direction—i.e., in the rack aisle if necessary. In other words, the drive device is located behind the lifting unit. This makes the drive device and all its components particularly easy to access, and the lower approach dimension is reduced considerably. For safety reasons, the shaft can be disconnected from the front. Moreover, safety can be increased by having two suspension means-one to the left and one to the right of the drive. However, the space required in the z-direction for the drive device and the motor increases. The components are “in the way” or in the rack aisle.

As a further variant, the drive device can be arranged in the storage rack in the z-direction or, in other words, in front of the lifting unit or below the storage rack. This results in a small space requirement in the z-direction and in a moderately lower approach dimension for the lifting unit. Safety can be increased by having two suspension means-one to the left and one to the right of the drive. However, the drive device is less easily accessible when located below the storage rack.

According to a particularly advantageous development, the drive device can be designed as a drive console for particularly good accessibility, which can be pulled like a drawer into the rack aisle or in the direction of an access area. A particularly rigid construction is advantageous.

As a further variant, the drive device can be located laterally next to the lifting unit in the x-direction. This variant offers advantageous accessibility to the drive unit and advantageous space requirements. The drive unit has only one belt thickness/width in the x-direction, while the previously described variants require twice the belt width. In terms of safety, one lateral drive device can also drive only a single lateral suspension means. The motor size is limited.

Alternatively or additionally, after requesting access to the hazard area according to step 1), at least one of the lifting units can be moved in the vertical direction to a preferred height and secured at the preferred height in the vertical direction (y).

The preferred height may, for example, be an ergonomic working height or a suitable height for carrying out troubleshooting/maintenance/repair work, etc. The operating personnel can, for example, move the lifting unit to the preferred height using a human-machine interface (HMI).

According to an embodiment of the method, the operating personnel can load the lifting unit or parts of the lifting unit at the preferred height onto a maintenance trolley in order to carry out troubleshooting/maintenance/repair work, etc. Specifically, when there is overhead space in the rack aisle, a maintenance trolley can be used as an aid to pick up defective parts and to introduce new parts, such as load-handling devices. This means that parts can be replaced more safely, easily, and therefore more quickly than with conventional racking systems. Preferably, two or more maintenance trolleys are present in a racking system. The defective part can then be pushed onto the first trolley, while the second trolley is already available with the intact replacement part. This minimizes overall downtime.

According to a preferred embodiment, it is possible in the method according to the present disclosure not to switch off all the rack operating devices, i.e., according to step 2), not to interrupt operation of the storage rack by all the rack operating devices. This increases the availability of the overall system and can also increase the output of the system, because the lifters/rack operating devices have to be stopped less frequently.

Instead, the individual rack operating devices can be switched off and/or secured independently of one another. If, for example, work is to be carried out on a specific rack operating device, only those rack operating devices which the operating personnel actually have to pass in order to access the specific rack operating device or those that are located so close to the operating personnel's access route that their operation actually poses a hazard can be switched off. Rack operating devices located far away do not necessarily have to be switched off. For example, after requesting access to the hazard area in accordance with step 1), only those lifting units of rack operating devices can be moved in the vertical direction to a lowest height and/or to a preferred height and secured at this height in the vertical y-direction which the operating personnel must pass on their way to the specific rack operating device on which the work is to be carried out or in the vicinity of which the operating personnel must linger/work. Whether a rack operating device is switched off may also depend upon whether it is located behind another separating protective device, such as a fence.

According to an advantageous embodiment of the method according to the present disclosure, the lifting unit can also be secured manually by the operating personnel.

A safety chain can be used for manually securing the lifting unit in the vertical direction. The lifting basket of the lifting unit can be attached to the vertically extending safety chain with a shackle. The safety chain can, for example, extend from the ground to a mast head. The chain can preferably be attached such that the operating personnel do not have to move under the lifting unit to secure and/or disconnect the lifting unit from the safety chain. Such securing makes sense in those cases where the lifting unit is malfunctioning/defective to an extent that it cannot be moved in the vertical direction to a lowest height as intended and/or moved to a preferred height and secured at the preferred height in the vertical y-direction. If the operating personnel carry out maintenance work on that lifting unit, such additional securing can take place at any possible height.

Alternatively, manual securing can be carried out by disconnecting the lifting unit from the drive unit or its lift drive shaft. Furthermore, alternatively or additionally, a safety gear or self-reinforcing safety device could be engaged so as to secure the falling lifting unit from falling down when loaded. Preferably, a retaining clamp when manually and/or automatically activated could create a frictional connection to the mast to safely prevent the falling lifting unit from falling down.

Manual securing by blocking the lift drive shaft or the deflection axis at the upper end of the mast is also possible—for example, by means of a bolt and a perforated disk. For example, a bolt assigned to the drive unit and arranged in a rotationally fixed manner is inserted into a hole in a perforated disk assigned to the lift drive shaft for securing purposes, so that rotation of the lift drive shaft and thus movement of the lifting unit become impossible. To implement such manual securing by blocking the lift drive shaft, a suspension means with appropriate safety is required. Two suspension means are advantageous. This type of unplugging is particularly useful when the drive device is arranged in an easily accessible position—for example, in front of the storage rack in the rack aisle.

The described variants for manually securing the lifting unit in the vertical direction can also be used to improve installation safety. The rack operating devices or lifting units are mounted using a chain hoist. For this purpose, a motor brake of a drive unit is manually bled. In this state, the lifting unit or its lifting basket can be pulled up and preferably secured using the chain hoist on the storage rack or mast. Strict safety instructions for installation are sensible in order to avoid work-related injuries. The chain hoist should be additionally secured with a lock on both the storage rack or mast and the lifting basket. Said lock must not be removed until the lifting basket is handed over for commissioning, even if the lifting basket is additionally secured.

The described safety chain and/or the described unplugging or disconnecting of the lifting unit from the drive unit or its lift drive shaft can be used as an additional safety measure during installation. This ensures a redundant safety system that includes a motor brake and additionally a safety chain and/or unplugging or disconnecting the lifting unit from the drive unit or its lift drive shaft, or the described blocking of the lift drive shaft. In addition, it is possible to remove the chain hoists between installing and commissioning the racking system. The lifting unit or lifting basket remains secured nevertheless.

Preferably, the lifting unit is secured manually by the operating personnel immediately after the operating personnel have been granted access to the hazard area in accordance with step 3), so that the relevant lifting units or rack operating devices are secured during the subsequent troubleshooting/maintenance/repair work, etc. The lifting units not affected by a fault can be moved in the vertical y-direction to a lowest height and/or to a preferred height and secured at the preferred height in the vertical direction. The faulty lifting unit is additionally secured as described above. This means that the operating personnel are protected and cannot be hit by a falling lifting unit. Also, the operating personnel can enter the redundantly secured lifting unit if necessary.

After having carried out troubleshooting/maintenance/repair work, etc., the operating personnel can remove the manual safety device and then leave the hazard area. Removal of the manual safety device can also be monitored to avoid damage during startup with a safety device still attached. Operation of the storage rack, which has been interrupted in accordance with step 2), can then be continued by the rack operating devices. Preferably, the operating personnel can resume operation via HMI.

If securing a lifting unit that should be secured automatically fails due to a defect, this preferably leads to an error message by the controller/control unit. In this case too, the lifting unit can be secured manually by an additional safety measure.

Preferably, the lifting unit can carry at least one load-handling device which can be moved horizontally in the lifting unit. According to an advantageous development of the method, after requesting access to the hazard area according to step 1), the load-handling device can be moved horizontally to a preferred position and secured in the preferred position in the horizontal direction.

The load-handling device can be secured manually in the horizontal z-direction by the operating personnel. Preferably, securing can be carried out automatically, in particular before the operating personnel are granted access to the hazard area in accordance with step 3). Automatic securing of the load-handling device in the horizontal z-direction can be achieved, for example, by means of a safe torque off (STO) function. In particular, if the load-handling device has an extension drive acting in the horizontal z-direction, which is independent of the drive device acting in the vertical y-direction, extension of the load-handling device can be efficiently prevented by STO on the extension drive.

According to an advantageous development, it is also possible for the securing of the lifting unit in the vertical y-direction to be carried out automatically, preferably before access to the hazard area is granted according to step 3).

Automatic securing can be provided instead of manual securing. It is also possible for securing to be carried out either manually by the operating personnel or automatically, in particular in order to generate redundancies with regard to the safety systems. Also, different lifting units of different rack operating devices can also be secured in different ways.

To automatically secure the lifting unit, a stationary securing device can preferably be extended. The stationary securing device can, for example, be assigned to the storage rack and/or a mast of the rack operating device. The mast can be arranged in a known manner at a distance in front of the storage rack or can be arranged directly on a rack upright of the racking system and/or integrated into the rack upright.

The stationary securing device can be a stationary maintenance support. The stationary maintenance support can be designed as a bracket that can be extended by motor to automatically secure the lifting unit, in particular the load-handling device. Motorized extension is advantageous in particular in applications where a plurality of lifts/rack operating devices have to be secured simultaneously, which would be too laborious to do manually and would therefore often be neglected.

To automatically secure the lifting unit, a securing device assigned to the lifting unit can be extended. The securing device assigned to the lifting unit can be an entrained maintenance support. For example, a bolt on the lifting basket of the lifting unit that is entrained with the lifting unit can be extended for automatic securing and engage in a corresponding securing element, such as a recess, which is located in a stationary manner, for example, on the mast or otherwise in a suitable position on the storage rack.

Preferably, a braking device of the lifting unit can be used to automatically secure the lifting unit. It can preferably be the motor brake of the drive unit described above. In order to automatically secure the lifting unit by means of a braking device, it is advantageous if the drive device has a second motor or a second motor brake as well as two suspension means with sufficient safety.

The dual design of the motor brake and suspension means can also increase safety during installation. If, for example, one of the suspension means-such as a belt-breaks during installation, the lifting unit cannot fall down because the other, second, redundant suspension means holds the lifting unit securely. Preferably, in this embodiment, additional or all components are designed redundantly so that a component may always fail without any problem.

Automatic securing by means of the braking device of the lifting unit can be particularly advantageous if it is not possible to otherwise secure the lifting unit or to move the lifting unit to the lowest height. This may be the case, for example, if there is a fault in the vertical movement of the lifting unit or if there is a fault in the data transmission, e.g., if an energy chain for cabling the rack operating device or the lifting unit breaks, or in the case of similar, rare faults. In these situations, without the use of the braking device, manual securing by means of a safety chain or disconnecting would be necessary in order to be able to linger under the load-handling device. In these cases, the variant of automatic securing by means of a braking device is particularly advantageous.

In an advantageous development, two drive devices can also be provided per lifting unit, which are located close to the ground and can preferably be arranged in the x-direction on both sides next to the lifting unit—in other words, to the left and right of the lifting unit. This design is advantageous in terms of safety, because the lifting unit can be equipped particularly conveniently with two suspension means and/or braking devices.

When granting access to the hazard area, a lockout/tagout system or a key transfer system can be used to increase safety.

The lockout/tagout system can significantly reduce the risk of work-related injuries. When using the lockout/tagout system, the rack operating devices and/or other devices are temporarily completely disconnected from the power supply or switched to STO before access to the hazard area is granted. During ongoing troubleshooting/maintenance/repair work, etc., no automatic movements can take place in the hazard area. The also prevents the rack operating devices and/or other devices from being switched on prematurely. Lockout/tagout can effectively prevent maintenance-related injuries in connection with machine energy and moving machine parts. In addition, the use of a lockout/tagout system increases awareness among operating personnel of the risk of accidents.

Depending upon the design of the method and racking system, the hazard area can be defined in different ways. Preferably, the hazard area is the area below the lifting units of the rack operating devices over the entire height of the lifting units. Alternatively or additionally, a rack aisle between the storage racks is part of the hazard area.

When the masts of the rack operating devices for the lifting units are integrated into the storage racks and/or replace the rack uprights, the masts are no longer located in the rack aisle, creating overhead access for the operating personnel in the rack aisle. The masts also do not get in the way because they are arranged to the side of the lifting units or load-handling devices.

In other words, the operating personnel can use the overhead access in the middle as a safe route to specifically reach a specific rack operating device in order to carry out troubleshooting/maintenance/repair work, etc. Without such overhead access, the operating personnel must pass all rack operating devices located upstream of the specific rack operating device on the operating personnel's route—for example, along the rack aisle.

If there are problems with a securing device, the operating personnel would have to move below unsecured lifting units or manually secure these lifting units individually beforehand. Such manual securing becomes possible with the means proposed herein. Since the operating personnel do not have to move below all upstream lifting units if the masts are appropriately developed, it is not mandatory to secure the corresponding lifting units in this case, similar to what was described at the beginning. It may be sufficient to secure those lifting baskets under which the personnel must linger.

The entire hazard area can be fenced, i.e., delimited by separating protective devices, such as a fence. For example, the areas below the lifting units can also be individually fenced. This makes it possible to ensure safe access for operating personnel to a specific rack operating device in the racking system, while other rack operating devices or even directly adjacent rack operating devices remain unsecured or are even in operation and serving storage racks.

The present disclosure also provides the control unit and the computer program product for carrying out the method, as described herein.

Furthermore, the present disclosure provides the securing device for automatically securing a lifting unit for safe access to the hazard area in the racking system, as described herein.

### BRIEF DESCRIPTION OF THE SEVERAL VIEWS OF THE DRAWINGS

There are various possibilities for designing and developing the teaching of the present disclosure in an advantageous manner. To this end, reference is made to the following explanation of preferred exemplary embodiments of the disclosure based upon the drawings. In connection with the explanation of the preferred exemplary embodiments of the present disclosure based upon the drawings, generally preferred embodiments and developments of the teaching are also explained. In the drawings:

FIG. 1 shows a top view from above of a racking system with rack operating devices according to the prior art,

FIG. 2 shows a perspective view of an embodiment of an improved rack operating device and racking system with integrated masts,

FIG. 3 shows a simplified block diagram of the method according to the present disclosure,

FIG. 4 shows a top view from above of an access concept for the method according to the present disclosure with a completely fenced hazard area,

FIG. 5 shows a top view from above of an access concept for the method according to the present disclosure with individually fenced hazard areas,

FIG. 6 shows another perspective view of the embodiment of the rack operating device and racking system of FIG. 2,

FIG. 7 shows a perspective view of a storage rack according to the embodiment of FIG. 2,

FIG. 8 shows a perspective view of a drive device which is arranged behind the lifting unit according to the embodiment of FIG. 2,

FIG. 9 shows a perspective view of a drive device according to another embodiment, which is arranged in front of the lifting unit,

FIG. 10 shows a perspective view of a drive device according to another embodiment, which is arranged below the lifting unit,

FIG. 11 shows a top view from above of another embodiment of the racking system with a drive unit that is arranged laterally next to the lifting unit,

FIG. 12 shows a top view from above of another embodiment of the racking systems with two drive units that are arranged laterally next to the lifting unit, and

FIG. 13 shows a perspective view of a racking system maintenance situation.

### DETAILED DESCRIPTION

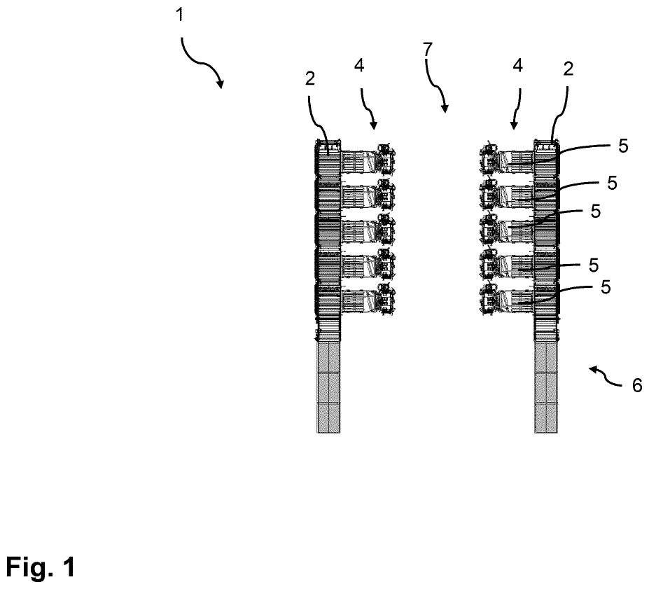

FIG. 1 shows a top view from above of a known racking system 1. The racking system 1 comprises a rack storage unit having two storage racks 2. A total of ten rack operating devices 5 are shown in front of or next to the storage racks 2, e.g., in two rows 4, at a distance from the storage rack 2. Further infeeding/outfeeding conveyor technology or rack structures 6 are indicated below in FIG. 1. FIG. 1 clearly shows that rows 4 of the rack operating devices 5 are at a considerable distance from the storage rack 2 and that rows 4 of the rack operating devices 5 take up comparatively much space in a rack aisle 7.

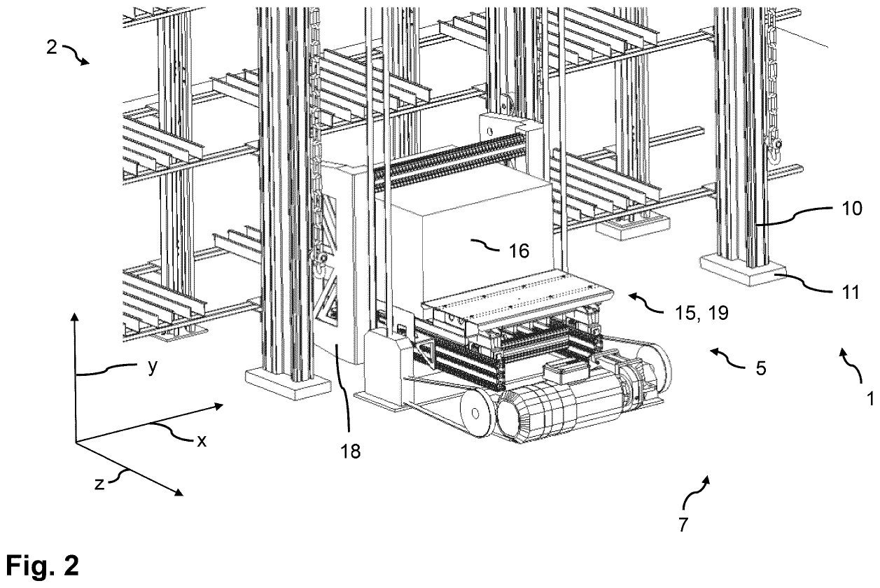

FIG. 2 shows an embodiment of an improved rack operating device 5 and of a racking system 1 with masts 10 which are integrated into the outer rack uprights of the racking system 1. The masts 10 replace the uprights and are supported on concrete foundations 11 at the ground. Rack aisle 7 is thus free of masts.

What can be seen is a load-handling device 15, with which many different conveying and/or stored goods 16—shown for example as cuboids in FIG. 1—can be gripped from below. This can be advantageous in particular for goods with very heterogeneous packaging—for example, supermarket goods. The load-handling device 15, like the lifting basket 18, is part of the lifting unit 19.

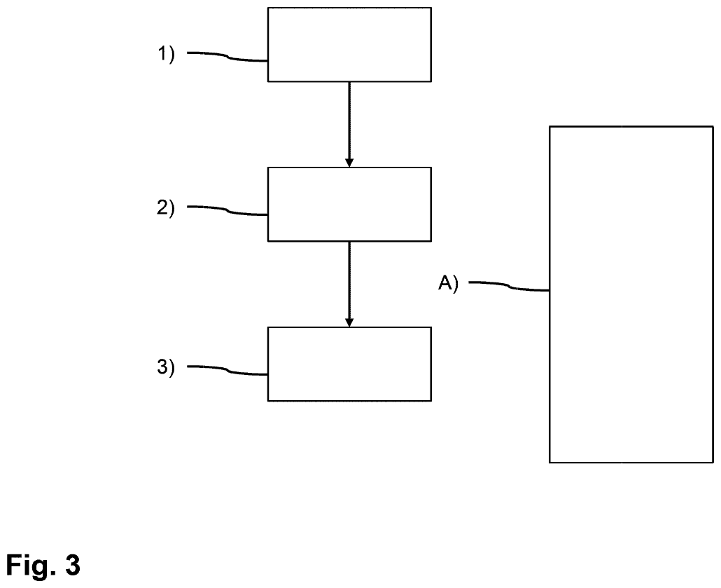

FIG. 3 shows a simplified block diagram of the method according to the present disclosure for safe access to a hazard area in a racking system, in particular to a rack operating device in a racking system designed as a storage and retrieval system.

According to step 1), the operating personnel first requests access to the hazard area. In step 2), any operation of the storage rack by at least one of the rack operating devices is interrupted. According to step 3), the operating personnel are granted access to the hazard area.

Furthermore, after requesting access to the hazard area according to step 1), a further step takes place. Depending upon the embodiment, the next step can take place before or after step 2), or before or after step 3). According to the further step, at least one of the lifting units is moved in the vertical direction to a lowest height and/or to a preferred height and secured at the preferred height in the vertical direction.

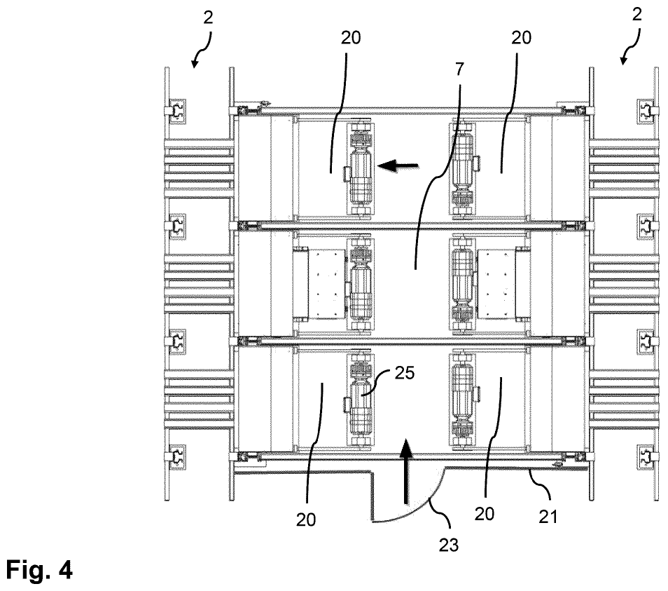

FIG. 4 shows a racking system where the hazard area includes rack aisle 7 and areas 20 below the lifting units of the rack operating devices. The entire hazard area is fenced with fence 21. The entire hazard area can be accessed via a single door 23, shown schematically, in that the operating personnel follow the procedure described. The arrows show the operating personnel's way to the rack operating device located at the top left. The operating personnel's way leads through the rack aisle, past the drive devices 25, which are arranged in the z-direction leading out of the storage rack, and are thus located in rack aisle 7.

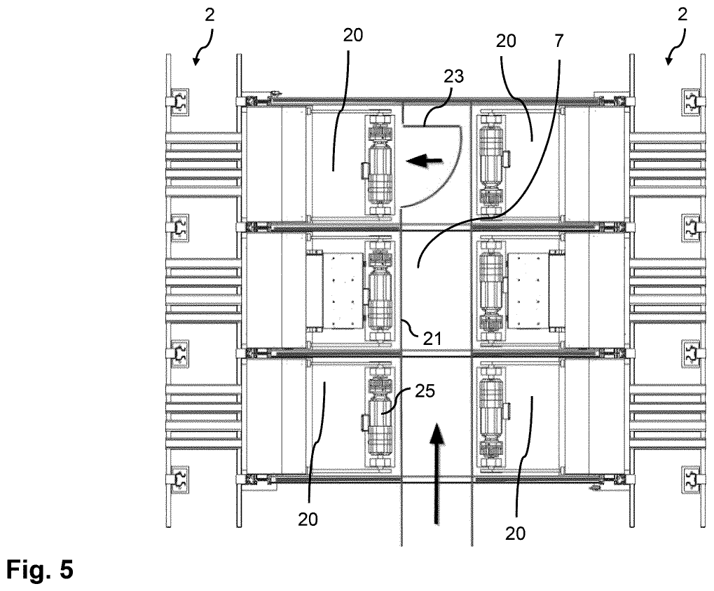

FIG. 5 shows a racking system where the hazard area includes only the areas 20 below the lifting units of the rack operating devices. The areas 20 are individually fenced with fences 21 and can each be accessed through a door. The door 23 leading to the rack operating device located at the top left is shown schematically. The arrows show the operating personnel's way to the rack operating device located at the top left. Rack aisle 7 allows overhead access between fences 21. It is also conceivable for rack aisle 7 to be also accessible through another fence and another door, as shown in FIG. 4.

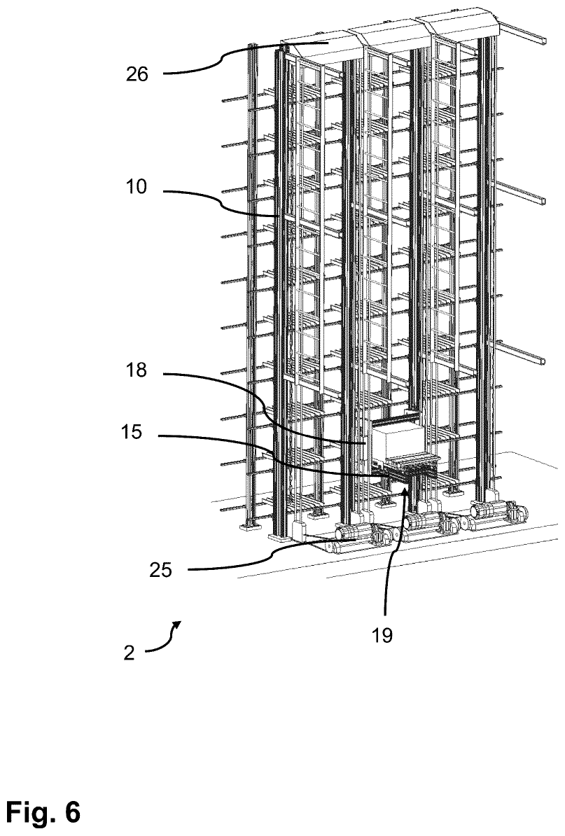

FIG. 6 shows the rack operating device 5 and the storage rack 2 of the rack system 1 of FIG. 2. The ladders 24 are clearly visible. Drive devices 25 are arranged at the bottom of the masts 10. The lifting unit 19 with its lifting basket 18 and load-handling device 15 can be seen. Cross struts in the form of crossbeams 26 are arranged at the top of the masts 10. The crossbeams 26 connect the mast heads and further brace the storage rack 2.

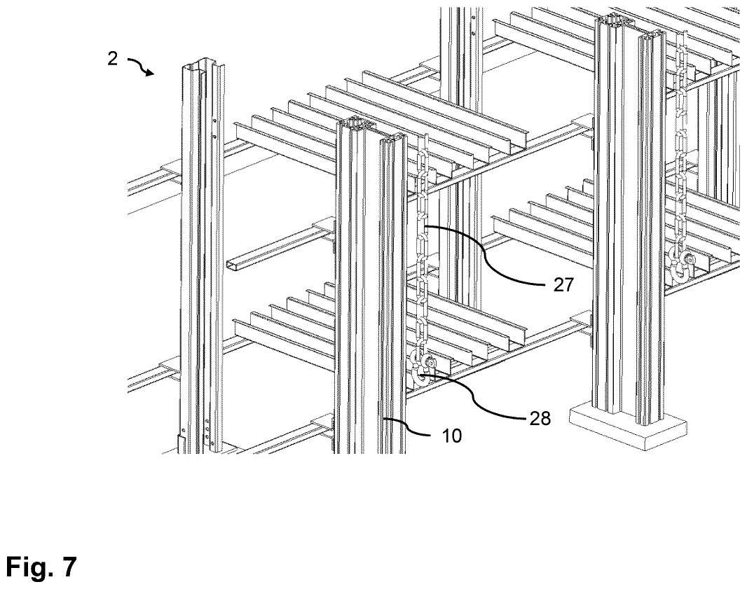

FIG. 7 shows that the outer rack uprights are replaced by masts 10, whereas conventional rack uprights are used inside the storage rack 2. A safety chain 27 is provided for manually securing the lifting unit (not shown in FIG. 7) in the vertical direction. The lifting basket of the lifting unit can be attached to the vertically extending safety chain 27—for example, with the shackle 28.

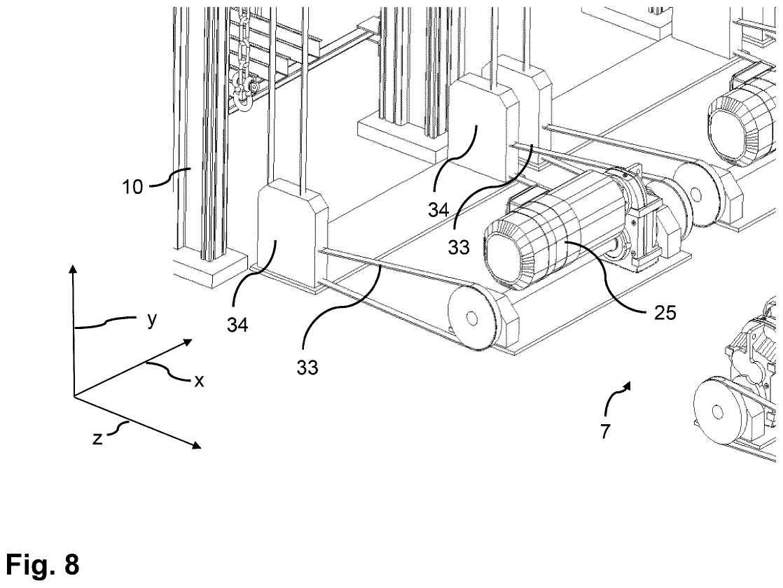

FIGS. 8 to 12 illustrate different variants and arrangements of drive devices 25 for the lifting unit 19. In the variant according to FIG. 8, the drive device 25 is located outside the storage rack 2 and in rack aisle 7. In other words, the drive device is located “behind” the lifting unit (not shown in FIG. 8). The drive devices 25 move lifting units up and down the masts 10 via two suspension means 33 extending in the vertical direction. The suspension means 33 are designed as belts. For this purpose, the suspension means 10 run over deflections 34, which are arranged essentially below the lifting unit.

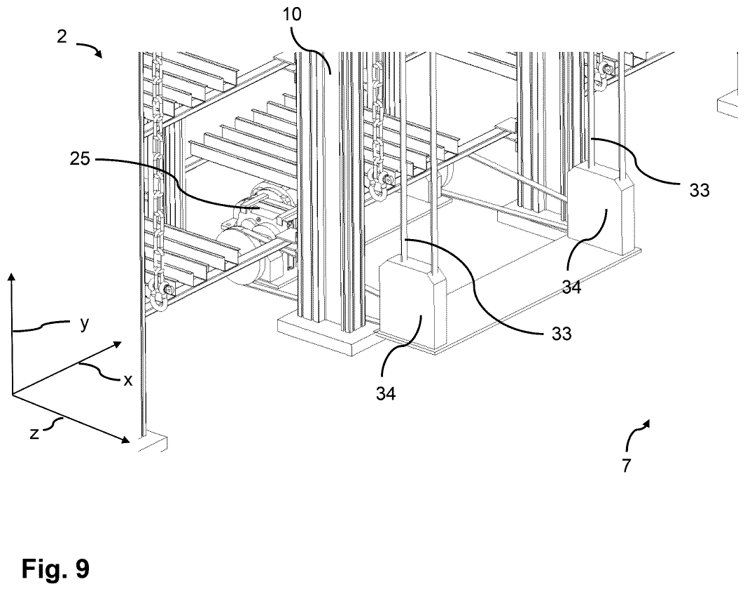

FIG. 9 shows a variant according to which the drive device 25 is arranged in the storage rack 2 in the z-direction or, in other words, in front of the lifting unit or below the storage rack. This means that the drive device 25 is less easily accessible, but the rack aisle 7 remains free.

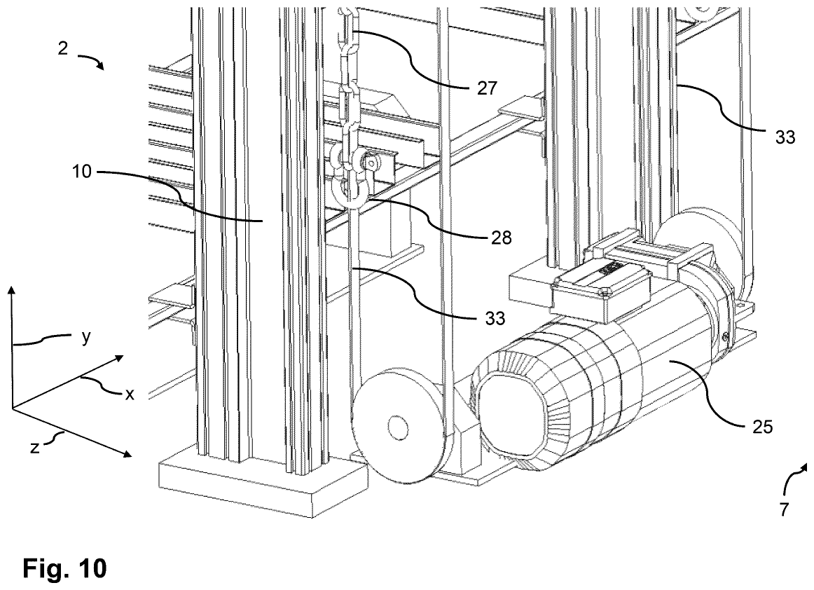

In the variant according to FIG. 10, the drive device 25 is located centrally below the lifting unit. Deflections are no longer required, but the lower approach dimension increases because the lifting unit can no longer move all the way down.

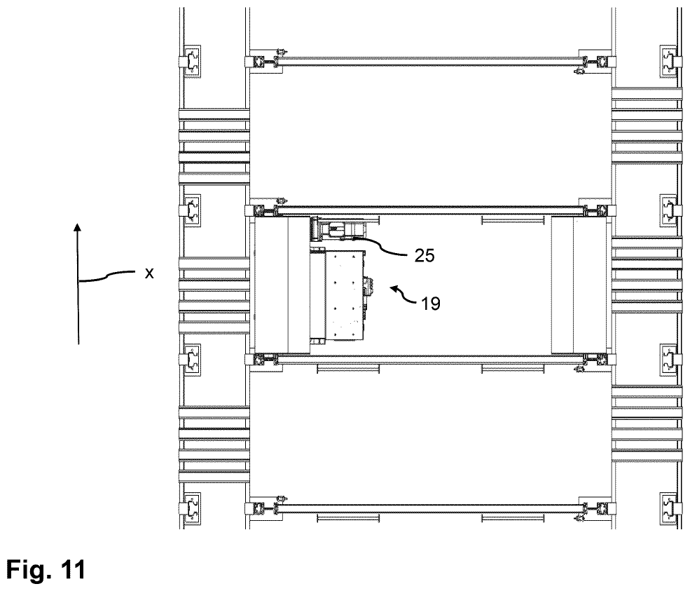

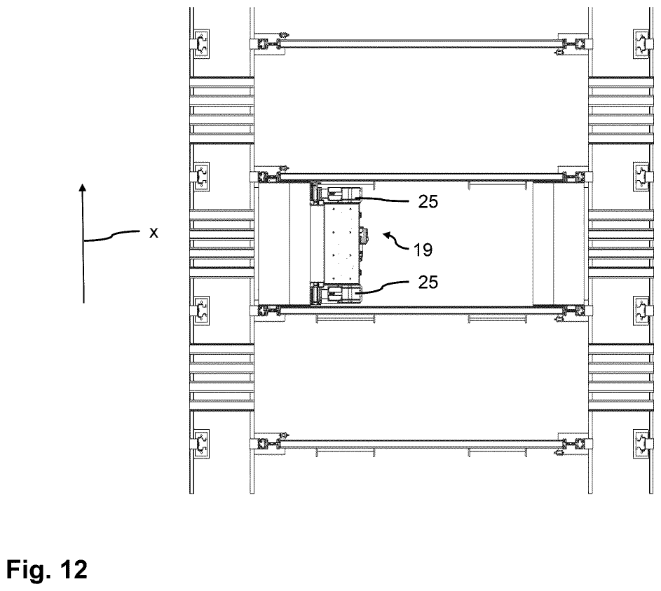

FIG. 11 shows a variant with the drive device 25 located laterally next to the lifting unit in the x-direction. In the embodiment according to FIG. 12, two drive devices 25 per lifting unit 19 are located on both sides next to the lifting unit 19 in the x-direction. FIGS. 11 and 12 show an optimized arrangement with at least three rack operating devices per storage rack in order to be able to optimally use the network of racks and to optimally install the rack operating devices. The embodiment according to FIG. 12 with two drive devices 25 is particularly suitable for automatically securing the lifting unit by means of a braking device due to the double design of motor brake and suspension means.

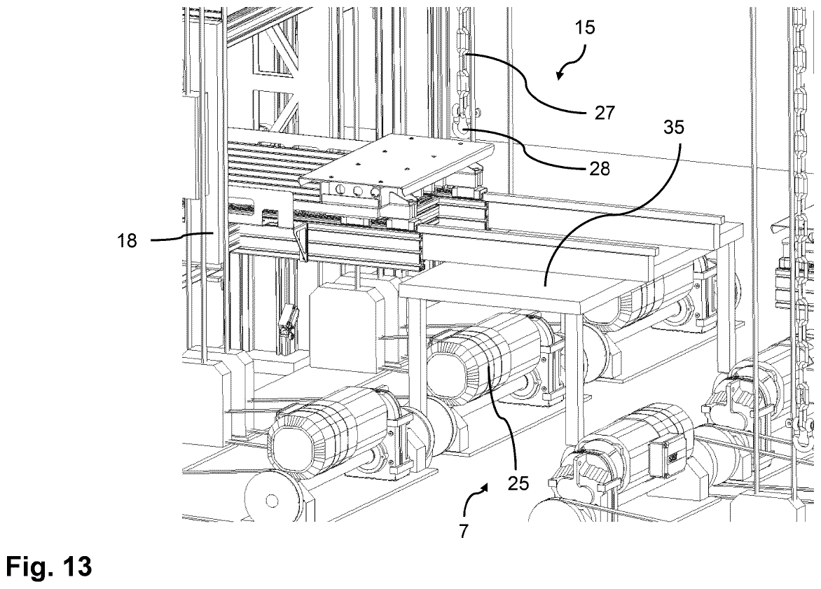

FIG. 13 shows a maintenance situation where a maintenance trolley 44 is moved into rack aisle 7. The load-handling device 15 can be removed from the lifting basket 18.

With regard to further advantageous embodiments of the device according to the present disclosure, reference is made to the general part of the description and to the appended claims in order to avoid repetitions.

Finally, it is expressly pointed out that the exemplary embodiments described above of the device according to the present disclosure serve only to explain the claimed teaching, but do not limit it to the exemplary embodiments.

### LIST OF REFERENCE SIGNS

1 Racking system
2 Storage rack
4 Rows
5 Rack operating device
6 Rack structures
7 Rack aisle
10 Mast
11 Concrete foundation
15 Load-handling device
16 Stored goods
18 Lifting basket
19 Lifting unit
20 Areas
21 Fence
23 Door
24 Ladder
25 Drive device
26 Crossbeam at the mast head
27 Safety chain
28 Shackle
33 Suspension means
34 Deflections
35 Maintenance trolley
1), 2), 3) Steps
x, y, z Directions in the coordinate system

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for safe access to a hazard area in a racking system, in particular to a rack operating device in a racking system designed as a storage and retrieval system,
wherein the racking system has a rack storage unit with at least one storage rack and at least one rack operating device for operating the at least one storage rack,
wherein the at least one storage rack has one or more compartments for stored goods in one rack level or in several rack levels arranged one above the other, and
wherein the rack operating device has a lifting unit arranged to be movable in a vertical direction,
comprising the following method steps:
1) requesting access to the hazard area by operating personnel,
2) interrupting any operation of the at least one storage rack by the rack operating device, and
3) granting access to the hazard area for the operating personnel,
the method further comprising,
after requesting access to the hazard area according to step 1), moving the lifting unit in the vertical direction to a lowest height, and/or to a preferred height and securing the lifting unit at the preferred height in the vertical direction.

2. The method according to claim 1, wherein the lifting unit is secured manually by the operating personnel.

3. The method according to claim 1, wherein the lifting unit is secured automatically.

4. The method according to claim 1, wherein the lifting unit carries at least one load-handling device which can be moved in the horizontal direction in the lifting unit,
the method further comprising, after requesting access to the hazard area according to step 1), moving the load-handling device in the horizontal direction to a preferred position and securing the load-handling device in the preferred position in the horizontal direction.

5. The method according to claim 3, further comprising extending a stationary securing device in order to automatically secure the lifting unit.

6. The method according to claim 3, further comprising extending a securing device associated with the lifting unit in order to automatically secure the lifting unit.

7. The method according to claim 3, further comprising using a braking device of the lifting unit for automatically securing the lifting unit.

8. The method according to claim 1, wherein granting access to the hazard area comprises use of a lockout/tagout system.

9. The method according to claim 1, wherein the hazard area includes areas below the lifting unit of the rack operating device and/or a rack aisle between storage racks.

10. The method according to claim 9, wherein the entire hazard area is fenced, and/or the areas below lifting units of rack operating devices are individually fenced.

11. The method according to claim 3, wherein the lifting unit is secured automatically before access to the hazard area is granted according to step 3).

12. A control unit that is configured to carry out the method according to claim 1.

13. A non-transitory computer-readable medium storing executable program commands which, when executed by a computer, cause the computer to carry out the method according to claim 1.

14. A securing device for automatically securing a lifting unit to a rack operating device in a racking system designed as a storage and removal system,
wherein the racking system has a rack storage unit with at least one storage rack and at least one rack operating device for operating the at least one storage rack,
wherein the at least one storage rack has one or more compartments for stored goods in one rack level or in several rack levels arranged one above the other,
wherein the at least one rack operating device has the lifting unit arranged to be movable in a vertical direction, and
wherein the securing device is stationary or associated with the lifting unit or is a braking device.
